(19) United States
(12) Patent Application Publication
(10) Pub. No.: US 2007/0024536 A1
(43) Pub. Date: Feb. 1, 2007

(54) Method for driving plasma display panel

(75) Inventor: Kyung-Wha Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/493,582

(22) Filed: Jul. 27, 2006

(30) Foreign Application Priority Data
Jul. 30, 2005 (KR) 70069/2005

(51) Int. Cl. G09G 3/28

(52) U.S. Cl. 345/67

(57) ABSTRACT

A method for driving a plasma display panel are disclosed to prevent an erroneous discharge according to an incomplete reset or according to a high speed driving and to improve the contrast. By further providing a certain bias voltage before an addressing voltage is provided, wall charges can be effectively formed. By preventing a dark discharge between X and Y electrodes, a level of the wall charges can be properly controlled to reduce a time needed for inducing an opposed discharge under addressing to improve luminance. By properly forming wall charges, an erroneous discharge can be prevented, and by providing a bias voltage for preventing the dark discharge, contrast characteristics can be improved.

### BACKGROUND OF THE INVENTION

1. Field of the Invention

The present invention relates to a method for driving a plasma display panel (PDP) and, more particularly, to a method for driving a PDP capable of preventing an erroneous discharge by using a bias voltage.

2. Description of the Related Art

A PDP device receives much attention as a next-generation display device together with a thin film transistor liquid crystal display (TFT LCD), an organic electro-luminescence (EL) and a field emission display (FED). In the PDP device, ultraviolet rays of 147 nm that are generated when a He+X3 or Ne+Xe gas is discharged in each discharge cell separated by barrier ribs excite R, G and B phosphors and an illumination phenomenon according to a difference of energy when the phosphor returns from the excited state to a base state is used.

FIG. 1 is a cross-sectional view showing a general AC driving type PDP device. First, a rear plate of the PDP device includes a blocking film 2 deposited on the entire surface of a rear glass substrate 1 and preventing infiltration of alkali ions contained in the substrate 1; an address electrode 3 of a discharge cell formed on a portion of the blocking film 2; a rear plate dielectric 4 formed on the entire surface of the blocking film 2 including the address electrode 3; barrier ribs 5 formed on the rear plate dielectric 4 and separating discharge cells; and a phosphor 6 formed on the rear plate dielectric 4 separated by the barrier ribs 5.

The front plate of the PDP device includes a transparent electrode 12 formed on a front glass substrate 11 and a bus electrode 13 for lowering a resistance value of the transparent electrode 12, a front plate dielectric 14 formed on the front glass substrate 11 including the transparent electrode 12 and the bus electrode 13, a passivation layer 15 formed on the entire surface of the front plate dielectric 14 to protect the front plate dielectric 14 against a plasma discharge. The front plate is installed such that the passivation layer 15 faces the barrier ribs 5 and the phosphor 6 of the rear plate.

In the AC driving type PDP device using three electrodes for driving, the electrodes are divided into, according to their function, the address electrode 3 positioned on the rear plate, and a scan electrode and a common electrode (also called a sustain electrode) formed as a pair of transparent electrodes 12 and the bus electrode formed on the front plate. The scan electrode and the common electrode have the same structure and operate with the same function during a sustain interval, so the both are known as the sustain electrode. Thus, to easily discriminate them according to a driving method, the address electrode 3 will be referred to as an X electrode, the scan electrode for outputting scan pulses during an address period will be referred to as a Y electrode, and the common electrodes having the same structure as the scan electrode will be referred to as a Z electrode.

The driving method using each electrode will be described with reference to FIG. 2 that shows driving waveforms.

First, a driving cycle of the plasma display panel device is a repetition of sub-frames (SF) (or sub-fields) including a reset period (including an erase period as necessary), an address period and a sustain period. Wall charges of each cell are uniformly initialized during the reset period, cells to be discharged are selected to perform an opposed discharge during the address period, and a continuous display discharge (surface discharge) is performed on the selected cells during the sustain period.

During the reset period, a ramp waveform (waveform with a certain slope) is applied between the Y electrode and the Z electrode to initialize the wall charges of each electrode. And at this time, a certain positive charge is accumulated on the X electrode that maintains a ground potential.

During the address period, as a positive voltage is applied, negative charges are accumulated, and when the address point (A) arrives to select a cell, a positive voltage is applied to the X electrode to push out the accumulated positive charges and a negative voltage is applied to the Y electrode to push out the accumulated negative charges, whereby an opposed discharge occurs by using the voltage differences between the wall voltage formed by the charges, the applied address voltage and the scan voltage.

Thereafter, during the sustain period, the surface discharge occurs alternately between the Y electrode and the Z electrode to sustain the discharge generated by the opposed discharge. Gray levels are represented by controlling the discharge degree during the sustain period at the sub-field level.

During each driving period, the actual start of driving of the PDP device becomes the opposed discharge during the address period during which cells to be illuminated are determined, so for an accurate opposed discharge, a scan waveform and an address waveform each with a sufficient length are provided as a high discharge firing voltage. This is because initialization of the wall charges by the reset may not be complete depending on an operation state of the panel. In particular, the X electrode always maintains a ground potential and operates only during the address period to perform the opposed discharge, so it is difficult to control to accumulate wall charges with a desired size in the X electrode during the reset period. Thus, X and Y electrode waveforms with a sufficient voltage and sufficient time should be provided to make the opposed discharge occur.

The driving waveforms in the related art do not have a problem in implementing a PDP panel below a certain resolution (XGA class), but they cause degradation of luminance or make it difficult to represent gray levels in implementing a PDP panel with higher resolution (SXGA class, full HD class).

Namely, as the resolution of the panel increases, the length of the address period among each allocation region of the sub-fields which are divided into the reset period, the address and the sustain period is lengthened and accordingly the sustain period is shortened. This means that the time for representing gray levels to be controlled during the sustain period is reduced to much degrade the luminance.

To sum up, in the related art method for driving the plasma display device, the opposed discharge is performed by driving the X electrode and the Y electrode during the address period. For the opposed discharge, the positive charges should be sufficiently accumulated in the X electrode before the discharge voltage is applied. However, because it is difficult to control the size of wall charges accumulated in the X electrode that sustains the ground potential, waveforms and the discharge voltage should be applied for a sufficient time during the opposed discharge. Thus, in case of a large panel, the length of the sustain period is shortened, which degrades the luminance and an erroneous discharge can occur due to the insufficient wall charges in the X electrode.

### SUMMARY OF THE INVENTION

Therefore, one object of the present invention is to provide a method for driving a plasma display panel which are capable of improving its luminance by reducing an address discharge time according to actual address waveforms by providing more bias voltage waveforms to an address electrode (X electrode) before the address waveforms are provided to charge wall charges in the address electrode, and of improving contrast by preventing a dark discharge.

Another object of the present invention is to provide a method for driving a plasma display panel which are capable of increasing a sustain period for representing gray levels by reducing the length of an address period by applying a negative voltage to an address electrode immediately before address waveforms are provided, to thereby forcibly accumulate positive charges with a desired level in the address electrode.

Still another object of the present invention is to provide a method for driving a plasma display panel whereby a negative voltage that increases and decreases with a slope is applied to an address electrode before address waveforms are provided to accumulate positive charges in the address electrode, thereby effectively accumulating or sustaining positive charges by the slope.

Yet another object of the present invention is to provide a method for driving a plasma display panel which are capable of preventing degradation of contrast characteristics by a dark discharge by applying a second positive bias voltage to an address electrode during a period during which reset waveforms are applied to a scan electrode to prevent the dark discharge according to a high reset voltage applied to the scan electrode.

Another object of the present invention is to provide a method for driving a plasma display panel which are capable of preventing rapid movement of charges and reducing power consumption by applying a second positive bias voltage to an address electrode during a period during which reset waveforms are provided to a scan electrode, and in this case, the second bias voltage increases or decreases with a certain slope.

To achieve these and other advantages and in accordance with the purpose of the present invention, as embodied and broadly described herein, there is provided a method for driving a plasma display panel which includes an address electrode (X) for applying an address voltage, a scan electrode (Y) for performing opposed discharge with the X electrode, and a common electrode (Z) for performing a surface discharge with the scan electrode (Y), including: applying a bias voltage of a certain level in a pulse type for formation of wall charges before an address voltage is applied to the address electrode (X).

To achieve the above objects, there is also provided a method for driving a plasma display panel including: applying a positive voltage during a certain time to an address electrode (X) while a positive voltage is being applied to a scan electrode (Y) during a reset period in order to prevent a dark discharge.

To achieve the above objects, there is also provided a method for driving a plasma display panel including: controlling waveforms of a bias voltage applied to the address electrodes to gradually increase or decrease with a slope.

To achieve the above objects, there is also provided a method for driving a plasma display panel including: a reset step of uniformly initializing wall charges of every cell of a panel; an address step of sequentially applying a scan voltage to a scan electrode (Y) to select cells to be driven; and a sustain step of sustaining discharges of cells selected in the addressing step, wherein a bias of a negative voltage level is applied to an address electrode (X) before the scan voltage is applied to the scan electrode (Y) in the addressing step.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view showing a general plasma display panel;

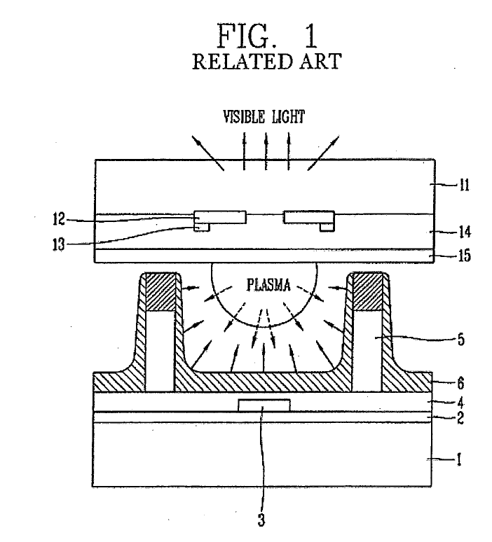

FIG. 2 is a waveform diagram showing a general panel driving method according to a related art;

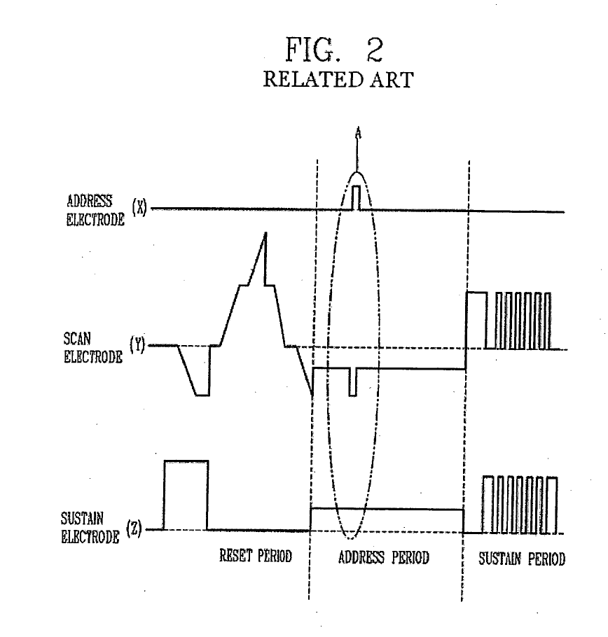

FIG. 3 is a waveform diagram showing a panel driving method according to one embodiment of the present invention;

FIG. 4 is a waveform diagram showing a panel driving method according to another embodiment of the present invention;

FIG. 5 is a waveform diagram showing a panel driving method according to still another embodiment of the present invention; and

FIG. 6 is a waveform diagram showing a panel driving method according to yet another embodiment of the present invention.

### DETAILED DESCRIPTION OF THE INVENTION

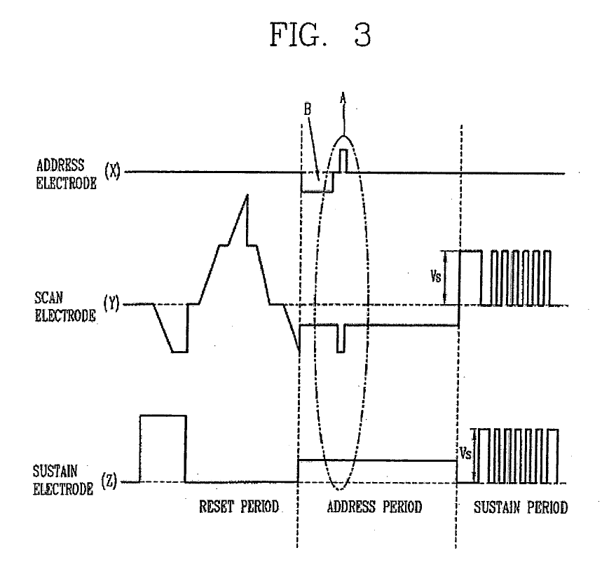

FIG. 3 is a waveform diagram showing a panel driving method according to one embodiment of the present invention. As shown, a negative bias voltage (B) is applied to an X electrode before an actual addressing voltage is applied.

During a reset period, wall charges of each electrode which has been changed during a sustain period of a previous sub-frame (SF) are initialized. Entering an address period, ideally, a small amount of negative charge remains in a Y electrode by ramp waveforms of the reset period, negative charges are accumulated in a Z electrode by a positive voltage continuously provided during the address period, and positive charges which have been pushed out according to the reset period operation of the Y-Z electrodes are accumulated in the X electrode. The wall voltage between the X and Y electrodes by the thusly accumulated wall charges raises a discharge voltage (a voltage between the X and Y electrodes at a time point ‘A’) provided for the opposed discharge, and a resultant value should be greater than a discharge firing voltage level. Namely, the magnitude of the voltage obtained by adding the address voltage and the wall voltage should be greater than the discharge firing voltage level (i.e., threshold voltage).

However, except when actually performing an addressing operation, the X electrode always maintains a ground potential, so the wall charges accumulated in the corresponding electrode cannot be directly controlled. Namely, entering the address period, a sufficient amount of positive charge is to be accumulated in the X electrode, which however cannot be guaranteed. Thus, because the address voltage must be applied with a sufficient magnitude and duration at the address time point (A), a high speed driving is not possible, and in this respect, if the related art driving method is applied to a large panel as it is, the luminance is degraded.

In the present invention, in order to maintain the wall charge accumulated in the X electrode in an optimum state before the time point (A) from which the opposed discharge starts to be performed by an actual addressing, a negative voltage of a certain duration is applied as the bias voltage (B). Preferably, the bias voltage (B) is applied before the actual addressing starts and after entering the address period during which the voltages of the Y and Z electrodes change. Accordingly, although the bias voltage (B) can be slightly different depending on a type of the sub-frames, it is preferably provided for a time period of about 0.5 μs to 50 μs, and in this case, as the voltage level, a negative voltage of about −10V to −50V is appropriate.

In the present invention, the bias voltage is provided to have a basic signal waveform for immediately applying a target bias voltage level or a ground level by controlling a switching unit, whereby the wall charges can be quickly moved.

That is, for the opposed discharge between the X and Y electrodes, positive charge of more than a certain level should be accumulated in the X electrode. In this respect, because the X electrode can be directly controlled to accumulate the positive charge by the bias voltage (B), the discharge voltage between the X and Y electrodes that is actually applied at the addressing time point (A) for the opposed discharge can be lowered and the duration of the corresponding voltage can be also reduced. Accordingly, the driving time of the entire address period can be considerably shortened, and thus, the length of the sustain period can be increased to better the luminance and gray characteristics and drive the high resolution panel by single scanning.

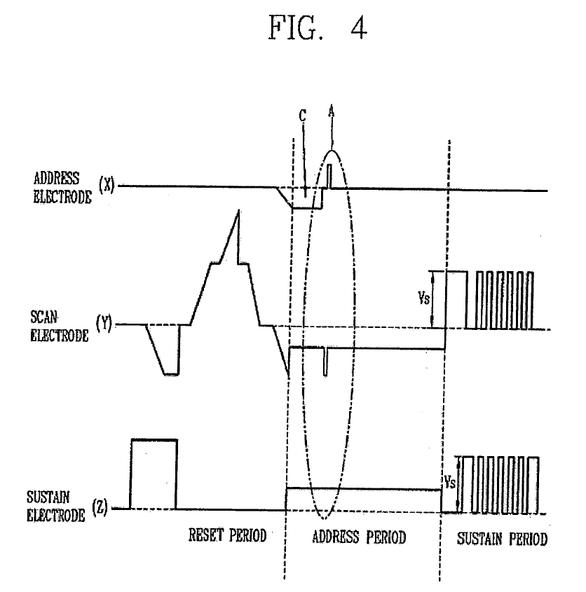

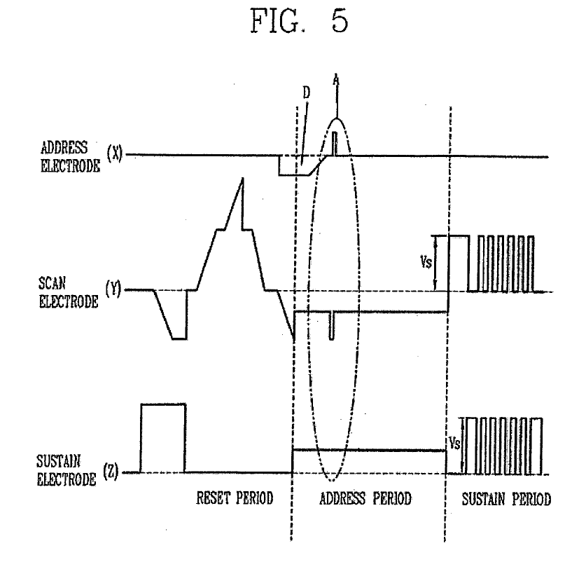

FIG. 4 is a waveform diagram showing a panel driving method according to another embodiment of the present invention, and FIG. 5 is a waveform diagram showing a panel driving method according to still another embodiment of the present invention.

Similarly to the case of FIG. 3, in the embodiments of FIGS. 4 and 5, a bias of a negative voltage level is applied to the X electrode. Before a discharge voltage is applied at time point (A) for the actual addressing, bias voltages (C and D) of a certain duration are applied to directly control the X electrode to accumulate positive charges. In the present exemplary embodiment of the present invention, when applying a bias voltage or finishing application of the voltage, the signal waveforms at a corresponding period have a ramp form with a positive or negative slope so that it can be insensitive to a change of a waveform at a time point when the positive charges accumulated in the X electrode starts or finishes applying the bias voltage. The signal waveform with the ramp interval can be formed by using an energy recovery circuit of a driver that provides the driving voltage, and in this respect, it is preferred to generate a signal waveform with a slope of 1V/μs to 10V/μs when the bias voltage is applied or finished. Namely, the simple ramp waveforms can be generated by using the known energy recovery circuit and the power consumption can thereby be reduced.

The signal waveform (C) according to the bias application as shown in FIG. 4 is obtained as the negative voltage gradually increases, making the charges around the X electrode not rapidly move, to accumulate positive charges, and the signal waveform (D) according to bias application as shown in FIG. 5 is obtained such that after the positive charge is accumulated in the X electrode, the gradually applied negative voltage is changed to a ground potential to thereby maintain the positive charge as it is.

The signal waveform according to the bias voltage applied during a certain period can be gradually increased to maintain the potential for a certain time and then gradually reduced, having a trapezoid shape (ramp wave-square wave-ramp wave). But in order to accumulate a maximum amount of positive charge in the X electrode within a limited time, the waveforms (ramp wave-square wave) as shown in FIGS. 4 and 5 or the waveform (square wave) as shown in FIG. 3 can be preferably used.

As mentioned above, by providing the bias of the negative voltage level to the X electrode, the wall voltage can be increased during the opposed discharge, ww23and the bias of the positive voltage level can be additionally provided to the X electrode to improve the contrast characteristics.

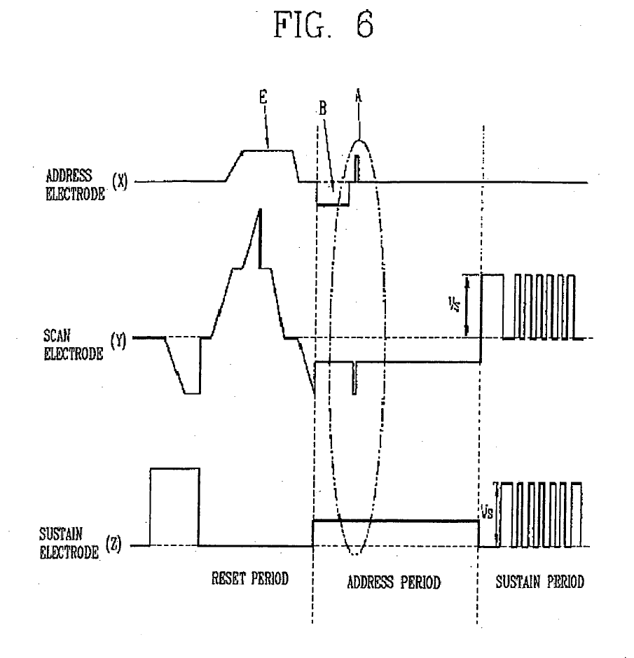

FIG. 6 is a waveform diagram showing a panel driving method according to yet another embodiment of the present invention. In detail, to the X electrode is additionally applied a signal of waveform (E) according to a bias of a positive voltage level during an interval including a time point at which a maximum voltage is applied within the period during which a high positive voltage is applied to the Y electrode during the reset period. And a signal waveform (B) is generated by the application of the negative bias voltage for generation of wall charges during the interval between application of the signal waveform (E) of the positive bias voltage and application of the signal waveform (A) of the address voltage for the opposed discharge.

The signal waveform (E) of the positive bias voltage is to prevent occurrence of dark discharge that can be generated between the X and Y electrodes due to a high voltage of the Y electrode ramp waveform. By applying the positive bias voltage to the X electrode at a voltage level of about 40V to 50V (E), the voltage difference with the Y electrode can be lowered so as not to generate the dark discharge, and thus, the contrast characteristics can be improved. In this case, the bias voltage can be applied within the relatively long reset voltage providing time (ramp interval) of the Y electrode, so the signal waveform of the positive bias voltage can be made to have a slope by using the energy recovery circuit.

The proper slope is about 1V/μs to 10V/μs, and the duration of the positive bias voltage can be different depending on the sub-frames but preferably it is about 0.5 μs to 100 μs. In this case, the desired voltage can be directly provided through direct switching without using the energy recovery circuit and it can be determined according to a type of the waveform that provides the negative bias voltage. Namely, when the energy recovery circuit is formed in the driving circuit unit that applies the voltage to the X electrode to provide the negative voltage bias Is waveform having a slope, the positive bias waveform is provided as a waveform with a slope by using the same. And when providing the negative voltage bias waveform as the square wave according to the providing of a simple voltage by the switching, the energy recovery circuit is not formed in the driver circuit unit that applies the voltage to the X electrode, and thus, the positive bias waveform can be provided also in the square waveform. In this respect, it is noted that if the energy recovery circuit is provided according to the intention of the designer, the waveform with a slope can be provided only when the positive bias is provided.

In order to provide the various levels of bias voltages and the related art address voltage, the X electrode driving unit needs to include a unit for selectively providing the address waveform of a certain level by a control signal and a unit for selectively providing the bias voltage of a certain level before the address voltage is provided, and the rapid rise and fall of the voltage in the form of the signal waveform according to the bias voltage should be necessarily performed and also a rise and fall of a voltage with a slope should be performed as necessary. Thus, a switching unit for directly applying the bias voltage and the ground voltage and the energy recovery unit for providing the signal waveform with the slope can be additionally included in the conventional X electrode driving unit.

In addition, because the address voltage of the X electrode for the opposed discharge can be reduced based on the above construction and operation, in case of the X electrode, a driver with low allowable power can be implemented for the driving unit.

As so far described, in the method for driving a plasma display panel according to the present invention, by simply applying the proper bias voltage to the address electrode (X electrode), the addressing speed can become faster, and thus, the luminance and the contrast performance can be improved.

In addition, when the present invention is applied to a large panel which has a higher resolution by reducing the unit address discharge time in the scan period that increases in proportion to the resolution of the panel, the sustain period for the gray scale representation can be maximized to thus improve the luminance and gray scale representation performance.

Moreover, when the present invention is applied to the large panel with high resolution for which scan lines must be driven according to a double scan method according to an increase in the resolution, even if the scan lines are driven according to a single scan method, sufficient luminance can be provided, so a change in the driving method and driving circuit can be reduced.

Furthermore, the dark discharge according to a high reset pulse can be prevented by applying the positive bias voltage to the address electrode while the reset pulse is being applied to the scan electrode, whereby the contrast performance can be improved.

Also, while the negative and/or positive bias voltage waveform is applied to the address electrode before the addressing waveform is provided, the start and/or end portion of the corresponding waveform can have a slope, so that the wall charges can be effectively formed and power can be effectively managed.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for driving a plasma display panel which includes an address electrode (X) for applying of an address voltage thereto, a scan electrode (Y) for performing opposed discharge in conjunction with the X electrode and a common electrode (Z) for performing a surface discharge in conjunction with the scan electrode (Y), comprising:
applying a bias voltage of a certain level in a pulse type to the address electrode (X) for formation of wall charges before the address voltage is applied to the address electrode (X).

2. The method of claim 1, wherein the bias voltage applied to the address electrode (X) is applied also during a certain portion of a reset period.

3. The method of claim 1, wherein the bias voltage applied to the address electrode (X) is applied in the opposite polarity to the address voltage and before the address voltage is applied.

4. The method of claim 1, wherein the bias voltage applied to the address electrode (X) is a negative voltage applied during a certain time to form wall charges in the address electrode (X) before the address voltage is applied thereto.

5. The method of claim 4, wherein the level of the negative bias voltage is less than 50V.

6. The method of claim 4, wherein a sustain time of the negative bias voltage is 0.5 μs to 50 μs.

7. The method of claim 1, further comprising:
applying a second bias voltage to the address electrode (X) of the opposite polarity to that of the bias voltage applied to the address electrode (X) during the reset period.

8. The method of claim 7, wherein the second bias voltage is less than 50V and has a sustain time of 0.5 μs to 100 μs.

9. The method of claim 1, wherein the bias voltage provided to the address electrode (X) has a voltage waveform that increases or decreases gradually with a slope.

10. The method of claim 9, wherein the slope of the voltage is within the range of 1V/μs to 10V/μs.

11. A method for driving a plasma display panel comprising:
a reset step of uniformly initializing wall charges of every cell of the panel;
an addressing step of sequentially applying a scan voltage to scan electrodes (Y) and applying a data pulse to address electrodes (X) to select cells to be driven; and
a sustain step of sustaining discharges of cells selected in the addressing step,
wherein a negative bias voltage is applied to the address electrodes (X) before the scan voltage is applied to the scan electrodes (Y) in the addressing step.

12. The method of claim 11, wherein the bias voltage is applied during a certain portion of a reset period in the reset step.

13. The method of claim 11, wherein the level of the bias voltage applied to the address electrodes (X) is less than 50V, and its sustain time is within the range of 0.5 μs to 50 μs.

14. The method of claim 11, wherein the reset step further comprises:
applying a second bias voltage to the address electrode (X) as a positive voltage during a period during which a positive voltage is applied to the scan electrode (Y).

15. The method of claim 14, wherein the positive voltage applied as the second bias voltage is less than 50V, and its sustain time is within the range of 0.5 μs to 100 μs.

16. The method of claim 11, wherein a waveform of a signal applied to the address electrode (X) in an interval defined according to application of the bias voltage gradually increases or decreases with a slope.

17. The method of claim 16, wherein the slope of the waveform of the signal is 1V/μs to 10V/μs.

18. A method for driving a 3 electrode-type plasma display panel in which a scan electrode, an address electrode and a sustain electrode are driven according to driving periods including a reset period, an address period and a sustain period, the method comprising:
entering the address period, applying a negative first bias voltage to the address electrode before an addressing discharge voltage is provided.

19. The method of claim 18, further comprising:
applying a positive voltage as a second bias voltage to the address electrode for canceling out an influence of the driving waveform based on the driving waveform of the scan electrode during the reset period.

20. The method of claim 18, wherein the first or second bias voltage is in the form of at least one of a square wave, a ramp-square wave in which a ramp interval that gradually increases or decreases is included in a start or end region of a square wave and a ramp-square wave-ramp wave in which a ramp interval that gradually increases or decreases is included in the start and end regions of the square wave.
